(19) United States
(12) Patent Application Publication
(10) Pub. No.: US 2026/0019519 A1
(43) Pub. Date: Jan. 15, 2026

(54) INFORMATION PROCESSING APPARATUS, INFORMATION PROCESSING METHOD, AND COMPUTER-READABLE, NON-TRANSITORY MEDIUM

(71) Applicant: PFU LIMITED, Kahoku-shi (JP)

(72) Inventors: Kenta Nagahashi, Kahoku-shi (JP); Ken Funaki, Kahoku-shi (JP); Ento Yamazaki, Kahoku-shi (JP); Osamu Miyakawa, Kahoku-shi (JP)

(21) Appl. No.: 19/256,978

(22) Filed: Jul. 1, 2025

(30) Foreign Application Priority Data
Jul. 10, 2024 (JP) 2024-110929

(51) Int. Cl. H04N 1/00

(52) U.S. Cl. CPC H04N 1/00896; H04N 1/00891; H04N 1/00904

(57) ABSTRACT

An information processing apparatus includes a non-volatile memory operable in response to being initialized and having a sleep function, processing circuitry, and a supply device to supply power to the non-volatile memory and the processing circuitry, wherein the processing circuitry initializes the non-volatile memory when a state of the information processing apparatus is an operating state in a case where the supply device starts to supply the power to the non-volatile memory and the processing circuitry, when the state of the information processing apparatus is not the operating state in the case where the supply device starts to supply the power to the non-volatile memory and the processing circuitry, brings the non-volatile memory into a sleep mode after initializing the non-volatile memory, and when the state of the information processing apparatus transitions to the operating state, brings the non-volatile memory out of the sleep mode without initializing the non-volatile memory.

### CROSS-REFERENCE TO RELATED APPLICATIONS

This patent application is based on and claims priority pursuant to 35 U.S.C. § 119 (a) to Japanese Patent Application No. 2024-110929, filed on Jul. 10, 2024, in the Japan Patent Office, the entire disclosure of which is hereby incorporated by reference herein.

### BACKGROUND

The present disclosure relates to an information processing apparatus, an information processing method, and a computer-readable, non-transitory medium.

Non-volatile memories that become operational in response to being initialized and have a sleep function, such as embedded multimedia cards (eMMCs), have been recently used to store programs.

A power-saving control device that downloads a program stored in a low-speed memory to a high-speed volatile memory and executes the program is disclosed. In a power-saving mode, the power-saving control device turns off the power of a central processing unit (CPU) and backs up the power to the high-speed volatile memory to hold the downloaded program.

### SUMMARY

The information processing apparatus according to one aspect of the present disclosure includes a non-volatile memory that stores a program, the non-volatile memory being operable in response to being initialized and having a sleep function; processing circuitry configured to execute a process; and a supply device to supply power supplied from an external power source to the non-volatile memory and the processing circuitry. The processing circuitry initializes the non-volatile memory when a state of the information processing apparatus is an operating state in a case where the supply device starts to supply the power to the non-volatile memory and the processing circuitry. When the state of the information processing apparatus is not the operating state in the case where the supply device starts to supply the power to the non-volatile memory and the processing circuitry, the processing circuitry brings the non-volatile memory into a sleep mode after initializing the non-volatile memory. When the state of the information processing apparatus transitions to the operating state, the processing circuitry brings the non-volatile memory out of the sleep mode without initializing the non-volatile memory.

The information processing method according to another aspect of the present disclosure includes supplying, by a supply device, power supplied from an external power source to a non-volatile memory that stores a program and processing circuitry that execute a process, the non-volatile memory being operable in response to being initialized and having a sleep function; initializing the non-volatile memory when a state of the information processing apparatus is an operating state in a case where the supply device starts to supply the power to the non-volatile memory and the processing circuitry; and when the state of the information processing apparatus is not the operating state in the case where the supply device starts to supply the power to the non-volatile memory and the processing circuitry, bringing the non-volatile memory into a sleep mode after initializing the non-volatile memory; and when the state of the information processing apparatus transitions to the operating state, bringing the non-volatile memory out of the sleep mode without initializing the non-volatile memory.

The computer-readable, non-transitory medium according to still another aspect of the present disclosure includes a computer-readable, non-transitory medium storing a computer program, which, when executed by processing circuitry, an information processing apparatus to perform an information processing method, the information processing apparatus including a non-volatile memory that is operable in response to being initialized and having a sleep function, the processing circuitry, and a supply device to supply power supplied from an external power source to the non-volatile memory and the processing circuitry. The information processing method includes: initializing the non-volatile memory when a state of the information processing apparatus is an operating state in a case where the supply device starts to supply the power to the non-volatile memory and the processing circuitry; when the state of the information processing apparatus is not the operating state in the case where the supply device starts to supply the power to the non-volatile memory and the processing circuitry, bringing the non-volatile memory into a sleep mode after initializing the non-volatile memory; and when the state of the information processing apparatus transitions to the operating state, bringing the non-volatile memory out of the sleep mode without initializing the non-volatile memory.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an information processing apparatus according to an embodiment of the present disclosure;

FIG. 2 is a diagram illustrating a conveyance path in the information processing apparatus illustrated in FIG. 1;

FIG. 3 is a block diagram schematically illustrating a configuration of the information processing apparatus illustrated in FIG. 1;

FIG. 4 is a schematic diagram illustrating an example of a power supply mechanism;

FIG. 5 is a diagram schematically illustrating an example configuration of a second storage device, a third storage device, and a processing circuit;

FIG. 6 is a flowchart illustrating an example of operations of an overall process;

FIG. 7 is a flowchart illustrating an example of operations of a sleep process;

FIG. 8 is a flowchart of an example of operations of a media reading process;

FIG. 9 is a schematic diagram illustrating another example of the power supply mechanism;

FIG. 10 is a flowchart illustrating another example of the operations of the sleep process; and

FIG. 11 is a block diagram schematically illustrating another example configuration of the processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing method, and a control program according to embodiments of the present disclosure will be described hereinafter with reference to the drawings. The technical scope of the present disclosure is not limited to the embodiments described below and covers the invention defined in the appended claims and its equivalents.

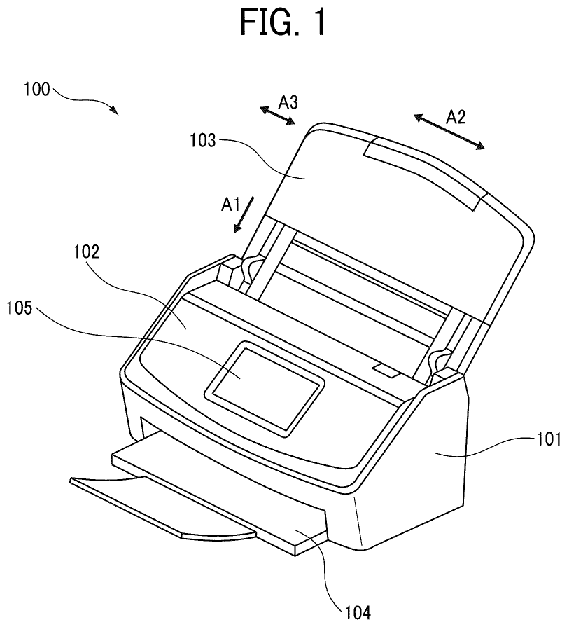

FIG. 1 is a perspective view of an information processing apparatus 100. In an example, the information processing apparatus 100 is configured as an image scanner.

The information processing apparatus 100 is a media conveying apparatus or an image reading apparatus that conveys media such as documents, captures images of the media, and ejects the media. Examples of the media include paper, thick paper, cards, booklets, and passports. The information processing apparatus 100 may be a facsimile machine, a copier, a printer multifunction peripheral (MFP), or the like. The information processing apparatus 100 may be a flatbed apparatus that captures images of media without conveying the media. The information processing apparatus 100 may be any apparatus such as a server, a personal computer (PC), a tablet PC, a smartphone, a mobile phone, or a printer.

In FIG. 1, arrow A1 indicates the direction in which the media are conveyed (also “media conveying direction A1”), arrow A2 indicates the width direction perpendicular to the media conveying direction A1, and arrow A3 indicates the height direction perpendicular to a media conveying path. In the following, upstream is toward the source in the media conveying direction Al, and downstream is away from the source in the media conveying direction A1. The width direction A2 is an example of a direction intersecting the media conveying direction A1.

The information processing apparatus 100 includes, for example, a lower housing 101, an upper housing 102, a media tray 103, an ejection tray 104, and a display operation device 105.

The upper housing 102 is positioned to cover the upper face of the information processing apparatus 100 and is engaged with the lower housing 101 via a hinge such that the upper housing 102 can be opened and closed to, for example, remove a jammed medium or clean the inside of the information processing apparatus 100.

The media tray 103 is engaged with the lower housing 101 and is rotatable around a hinge. The media tray 103 is positioned to cover the lower housing 101 and the upper housing 102 when the information processing apparatus 100 is not in use, and functions as an outer cover. On the other hand, when the information processing apparatus 100 is in use, the media tray 103 is positioned such that a medium can be placed on the media tray 103 to hold the medium to be fed and conveyed. The ejection tray 104 is engaged with the lower housing 101 and holds the medium that has been ejected. The ejection tray 104 may be engaged with the upper housing 102 via a hinge or the like.

The display operation device 105 includes a display such as a liquid crystal display or an organic electroluminescent (EL) display, and an interface circuit that outputs image data to the display, and displays the image data on the display. The display operation device 105 further includes a touch panel input device and an interface circuit that acquires a signal from the input device, receives an input operation performed by a user, and outputs an operation signal corresponding to the input operation performed by the user. The display and the operation device may be separate from each other.

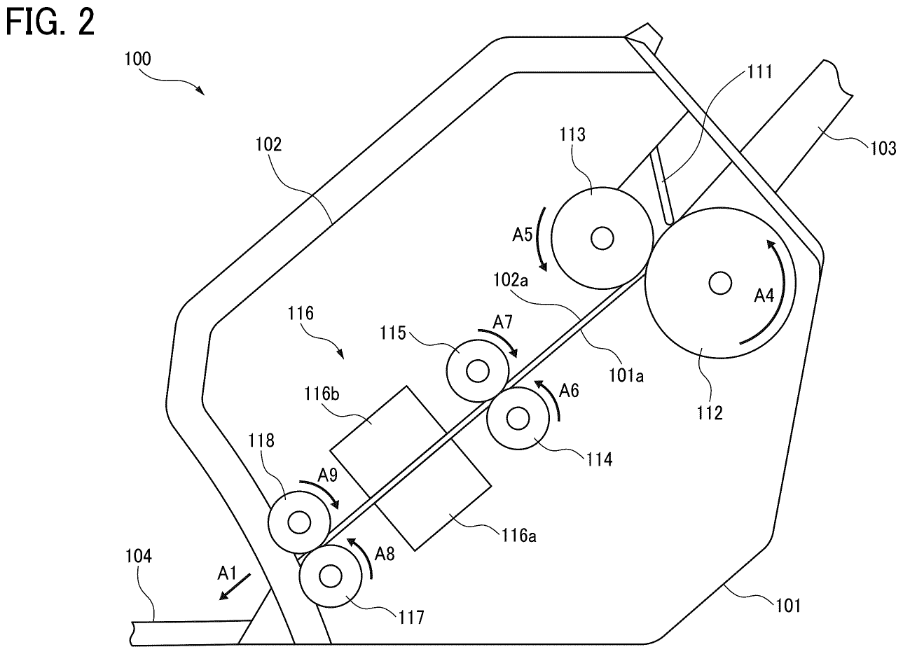

FIG. 2 is a diagram illustrating a conveyance path in the information processing apparatus 100.

The conveyance path in the information processing apparatus 100 includes, for example, a media sensor 111, a feed roller 112, a separation roller 113, a first conveyance roller 114, a second conveyance roller 115, an imaging device 116, a first ejection roller 117, and a second ejection roller 118.

The conveyance path may include two or more feed rollers 112, two or more separation rollers 113, two or more first conveyance rollers 114, two or more second conveyance rollers 115, two or more first ejection rollers 117, and/or two or more second ejection rollers 118. In this case, the two or more feed rollers 112, the two or more separation rollers 113, the two or more first conveyance rollers 114, the two or more second conveyance rollers 115, the two or more first ejection rollers 117, and/or the two or more second ejection rollers 118 are arranged side by side and spaced apart in the width direction A2.

The upper face of the lower housing 101 defines a lower guide 101a for the media conveying path. The lower face of the upper housing 102 defines an upper guide 102a for the media conveying path. As illustrated in FIG. 2, the media conveying path is a so-called straight path, and the vertical relative positions of the front and back sides of a medium remain unchanged from the state in which the medium is placed on the media tray 103 before being conveyed to the state in which the medium is placed on the ejection tray 104 after being ejected. Since the media conveying path is a straight path, the information processing apparatus 100 is compact.

The media sensor 111 is located upstream of the feed roller 112 and the separation roller 113. The media sensor 111 includes a contact detection sensor and detects whether a medium is placed on the media tray 103. The media sensor 111 generates and outputs a media signal whose signal value changes depending on whether a medium is placed on the media tray 103. The media sensor 111 is not limited to a contact detection sensor, and may be any sensor such as an optical detection sensor that can detect the presence of a medium.

The feed roller 112 is located in the lower housing 101 and sequentially separates and feeds the media placed on the media tray 103 one by one, starting from the bottom. The separation roller 113 is a so-called brake roller or retard roller. The separation roller 113 is located in the upper housing 102 and faces the feed roller 112 to separate the media placed on the media tray 103 one by one. The separation roller 113 is rotatable in a direction A5 opposite to the rotation direction for conveying the media (may be hereinafter referred to as a media feeding direction). Alternatively, the separation roller 113 is stoppable. Instead of the separation roller 113, a separation pad may be used.

The first conveyance roller 114 and the second conveyance roller 115 are located downstream of the feed roller 112 and the separation roller 113 in the media conveying direction A1, and face each other. The first conveyance roller 114 and the second conveyance roller 115 convey the media fed by the feed roller 112 and the separation roller 113 to the imaging device 116.

The imaging device 116 captures images of the media conveyed by the first conveyance roller 114 and the second conveyance roller 115. The imaging device 116 includes a first imaging device 116a and a second imaging device 116b facing each other with the media conveying path therebetween.

The first imaging device 116a includes an imaging sensor that is a unity-magnification contact image sensor (CIS) including complementary metal oxide semiconductor (CMOS) imaging elements aligned linearly in a main scanning direction. The first imaging device 116a further includes a lens that forms an image on the imaging elements, and an analog-to-digital (A/D) converter. The A/D converter amplifies electrical signals output from the imaging elements and performs analog-to-digital (A/D) conversion. The first imaging device 116a captures images of the front side of the media being conveyed to generate input images sequentially, and outputs the input images.

Similarly, the second imaging device 116b includes an imaging sensor that is a unity-magnification CIS including CMOS imaging elements aligned linearly in the main scanning direction. The second imaging device 116b further includes a lens that forms an image on the imaging elements and an A/D converter. The A/D converter amplifies electrical signals output from the imaging elements and performs A/D conversion. The second imaging device 116b captures images of the back side of the media being conveyed to generate line images sequentially, and outputs the line images.

The information processing apparatus 100 may include either the first imaging device 116a or the second imaging device 116b to read only one side of the media. In one example, the imaging sensor may be a line sensor that employs a unity-magnification CIS including charge-coupled device (CCD) imaging elements. In another example, the imaging sensor may be a reduction-magnification line sensor including CMOS or CCD imaging elements.

The first ejection roller 117 and the second ejection roller 118 are located downstream of the imaging device 116 in the media conveying direction A1, and face each other. The first ejection roller 117 and the second ejection roller 118 eject the media that are conveyed by the first conveyance roller 114 and the second conveyance roller 115 and are processed (or imaged) by the imaging device 116 to the ejection tray 104.

A medium placed on the media tray 103 is conveyed between the lower guide 101a and the upper guide 102a in the media conveying direction A1 as the feed roller 112 rotates in a direction indicated by arrow A4 in FIG. 2, that is, in the media feeding direction. When two or more media are placed on the media tray 103, a medium in contact with the feed roller 112 is separated from the rest of the media on the media tray 103 due to the action of the feed roller 112 and the separation roller 113. This operation limits the feeding of the media other than the separated medium (prevention of multifeed).

The medium is fed between the first conveyance roller 114 and the second conveyance roller 115 while being guided by the lower guide 101a and the upper guide 102a. The medium is fed between the first imaging device 116a and the second imaging device 116b as the first conveyance roller 114 and the second conveyance roller 115 rotate in directions indicated by arrows A6 and A7 in FIG. 2, respectively. The medium read by the imaging device 116 is ejected onto the ejection tray 104 as the first ejection roller 117 and the second ejection roller 118 rotate in directions indicated by arrows A8 and A9 in FIG. 2, respectively.

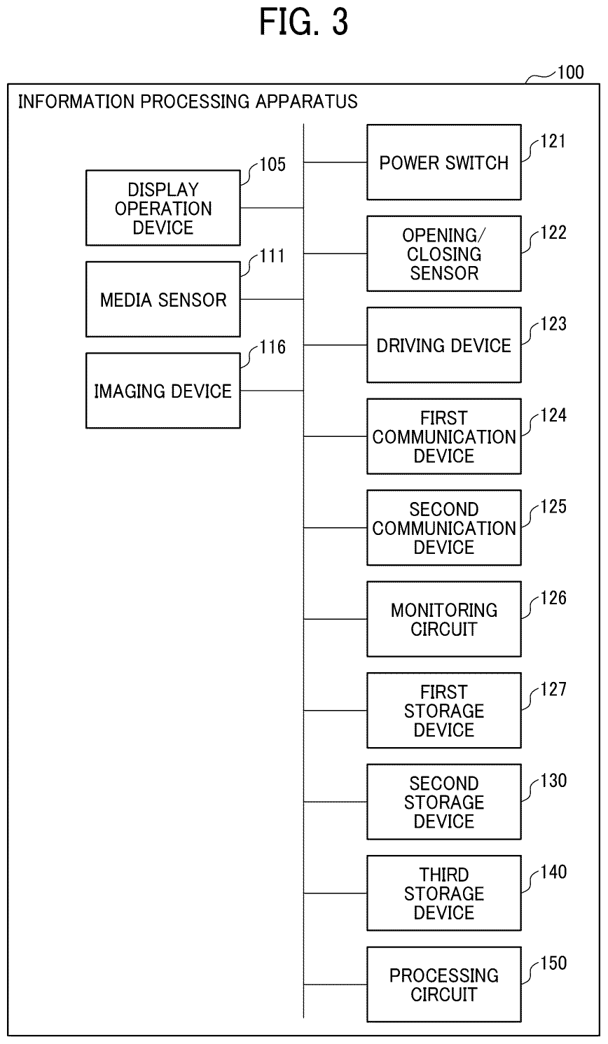

FIG. 3 is a block diagram schematically illustrating a configuration of the information processing apparatus 100.

The information processing apparatus 100 includes, in addition to the components described above, for example, a power switch 121, an opening/closing sensor 122, a driving device 123, a first communication device 124, a second communication device 125, a monitoring circuit 126, a first storage device 127, a second storage device 130, a third storage device 140, and a processing circuit 150. The display operation device 105, the media sensor 111, the imaging device 116, the power switch 121, the opening/closing sensor 122, the driving device 123, the first communication device 124, the second communication device 125, the monitoring circuit 126, the first storage device 127, the second storage device 130, the third storage device 140, and the processing circuit 150 are connected to each other via a CPU bus or the like.

The power switch 121 includes a switch or a button disposed on a surface of the lower housing 101 or the upper housing 102, and an interface circuit that acquires a signal from the switch or the button. The power switch 121 outputs a state signal indicating whether the power switch 121 is in on or off position.

The opening/closing sensor 122 is a contact detection sensor that detects the open or closed state of the media tray 103. The opening/closing sensor 122 detects whether the media tray 103 is open or closed with respect to the lower housing 101 or the upper housing 102 by, for example, detecting whether a protrusion provided on the media tray 103 is engaged with a recess provided in the lower housing 101 or the upper housing 102. The opening/closing sensor 122 outputs an opening/closing signal indicating whether the media tray 103 is open or closed to the processing circuit 150.

The driving device 123 includes one or more motors. The driving device 123 generates a driving force for rotating the feed roller 112, the separation roller 113, the first conveyance roller 114, the second conveyance roller 115, the first ejection roller 117, and/or the second ejection roller 118 in response to a control signal from the processing circuit 150. The driving device 123 is, for example, a direct current (DC) motor. The driving device 123 may be a motor other than a DC motor, such as a stepping motor. One of the first conveyance roller 114 and the second conveyance roller 115 may be a driven roller that is driven by the other of the first conveyance roller 114 and the second conveyance roller 115. One of the first ejection roller 117 and the second ejection roller 118 may be a driven roller that is driven by the other of the first ejection roller 117 and the second ejection roller 118.

The first communication device 124 includes an antenna that transmits and receives wireless signals, and a wireless communication interface circuit for transmitting and receiving signals through a wireless communication line according to a predetermined communication protocol. The predetermined communication protocol is, for example, a wireless local area network (LAN) communication protocol. The first communication device 124 is communicably connected to another communication device (e.g., a PC or a mobile information terminal) directly or via a network such as a wireless LAN to transmit and receive input images and various types of information. The first communication device 124 is connected to the processing circuit 150 via an interface circuit compliant with an interface standard such as Secure Digital Input/Output (SDIO). The first communication device 124 may include an interface circuit compliant with a short-range wireless communication standard such as Bluetooth®.

The second communication device 125 includes a wired communication interface circuit for transmitting and receiving signals through a wired communication line according to a communication protocol such as a wired LAN. The second communication device 125 is communicably connected to another communication device (e.g., a PC or a mobile information terminal) directly or via a network such as a LAN to transmit and receive input images and various types of information. The second communication device 125 may include an interface circuit compliant with a serial bus such as a universal serial bus (USB). Further, the second communication device 125 detects whether a communication cable is inserted into a communication connector, and outputs an insertion signal indicating whether the communication cable is inserted into the communication connector to the processing circuit 150.

The monitoring circuit 126 is, for example, a digital signal processor (DSP), a large scale integration (LSI) circuit, an application specific integrated circuit (ASIC), or a field-programmable gate array (FPGA). The monitoring circuit 126 receives an operation signal from the display operation device 105, receives a media signal from the media sensor 111, receives a state signal from the power switch 121, receives an opening/closing signal from the opening/closing sensor 122, and receives an insertion signal from the second communication device 125. The monitoring circuit 126 controls a switching device described below according to the received signals. The monitoring circuit 126 is provided to be operable with lower power consumption than the processing circuit 150.

The first storage device 127 is a volatile memory such as a random access memory (RAM). The first storage device 127 is loaded with a computer program stored in the third storage device 140, and stores the computer program. The first storage device 127 also stores data used in various processes for the information processing apparatus 100.

The second storage device 130 is a non-volatile memory such as a flash read only memory (ROM). The second storage device 130 stores, for example, computer programs used in various processes for the information processing apparatus 100. The computer programs may be installed in the second storage device 130 from a computer-readable portable recording medium by using a known setup program or the like. Examples of the portable recording medium include a compact disc read-only memory (CD-ROM) and a digital versatile disc read-only memory (DVD-ROM). Alternatively, the computer programs may be distributed from a server or the like and installed in the second storage device 130.

The third storage device 140 is a non-volatile memory, such as an eMMC. The eMMC includes a NAND flash memory and a control circuit. An eMMC is less expensive than a flash ROM. An eMMC may be used as the third storage device 140 to reduce the cost of the information processing apparatus 100. The third storage device 140 becomes operational in response to being initialized and has a sleep function. The third storage device 140 is initialized to become operable. The sleep function is a function that keeps the third storage device 140 operating with low power consumption once the third storage device 140 has been initialized. After returning from sleep mode, the third storage device 140 can operate without being reinitialized. The third storage device 140 is initialized in response to receipt of an initialization signal from the processing circuit 150, enters a sleep mode in response to receipt of a sleep signal during operation, and exits the sleep mode in response to receipt of an awake signal from the processing circuit 150 during sleep mode. The third storage device 140 may be a solid state drive (SSD) or the like.

The third storage device 140 stores, for example, computer programs, databases, and tables used in various processes for the information processing apparatus 100. The computer programs may be installed in the third storage device 140 from a computer-readable portable recording medium by using a known setup program or the like. Examples of the portable recording medium include a CD-ROM and a DVD-ROM. Alternatively, the computer programs may be distributed from a server or the like and installed in the third storage device 140. The third storage device 140 is connected to the processing circuit 150 via an interface circuit compliant with an interface standard such as SDIO.

The processing circuit 150 is an example of a processor that executes a process. The processing circuit 150 operates according to programs stored in advance in the second storage device 130 and the third storage device 140. The processing circuit 150 is, for example, a CPU. The processing circuit 150 may be, for example, a DSP, an LSI circuit, an ASIC, or an FPGA. The processing circuit 150 is connected to and controls, for example, the display operation device 105, the media sensor 111, the imaging device 116, the power switch 121, the opening/closing sensor 122, the driving device 123, the first communication device 124, the second communication device 125, the monitoring circuit 126, the first storage device 127, the second storage device 130, and the third storage device 140. The processing circuit 150 performs, for example, drive control of the driving device 123, and imaging control of the imaging device 116, based on a media signal acquired from the media sensor 111.

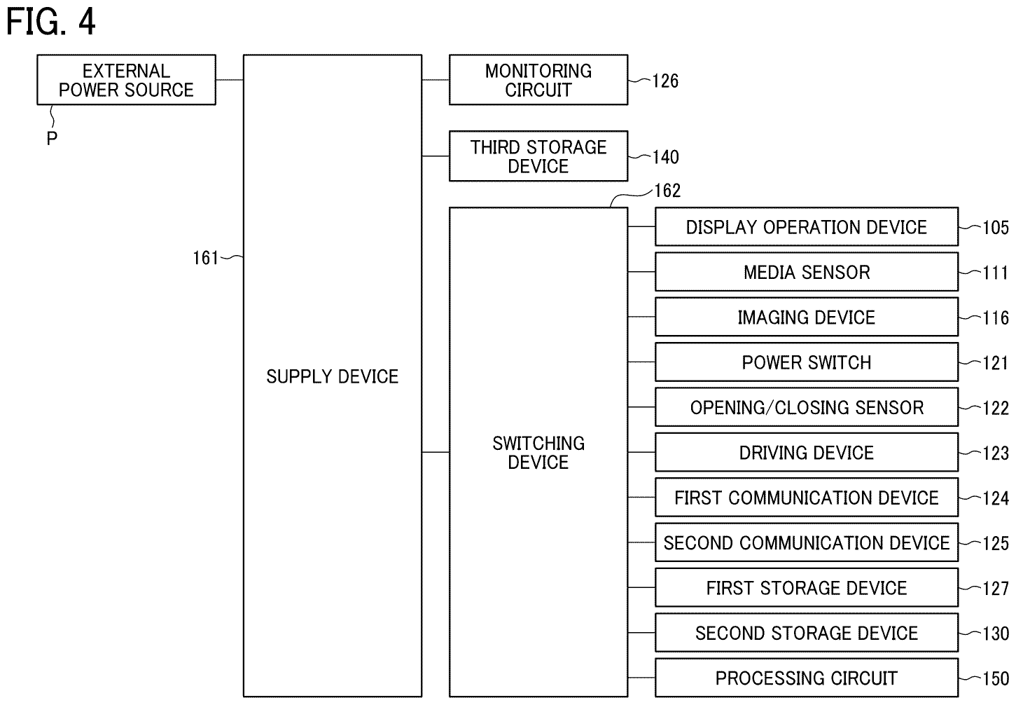

FIG. 4 is a schematic diagram illustrating a power supply mechanism of the information processing apparatus 100.

As illustrated in FIG. 4, the information processing apparatus 100 further includes a supply device 161 and a switching device 162.

The supply device 161 is an example of a supply unit. The supply device 161 receives power supplied from an external power source P. The supply device 161 supplies the power supplied from the external power source P to the display operation device 105, the media sensor 111, the imaging device 116, the power switch 121, the opening/closing sensor 122, the driving device 123, the first communication device 124, the second communication device 125, the first storage device 127, the second storage device 130, and the processing circuit 150 through the switching device 162. The supply device 161 also supplies the power supplied from the external power source P directly to the monitoring circuit 126 and the third storage device 140 by bypassing the switching device 162.

The supply device 161 may also supply power directly to the display operation device 105, the media sensor 111, the imaging device 116, the power switch 121, the opening/closing sensor 122, the driving device 123, the first communication device 124, the second communication device 125, the first storage device 127, the second storage device 130, and/or the processing circuit 150 by bypassing the switching device 162. The supply device 161 may supply power to the monitoring circuit 126 and/or the third storage device 140 through the switching device 162.

The switching device 162 is an example of a switching unit. The switching device 162 is, for example, a semiconductor switch. The switching device 162 may be a mechanical switch. The switching device 162 switches between supplying and not supplying the power, which is supplied from the external power source P to the supply device 161, to the display operation device 105, the media sensor 111, the imaging device 116, the power switch 121, the opening/closing sensor 122, the driving device 123, the first communication device 124, the second communication device 125, the first storage device 127, the second storage device 130, and/or the processing circuit 150. The switching device 162 is operable to switch between supplying and not supplying power to each of the display operation device 105, the media sensor 111, the imaging device 116, the power switch 121, the opening/closing sensor 122, the driving device 123, the first communication device 124, the second communication device 125, the first storage device 127, the second storage device 130, and the processing circuit 150. The switching device 162 switches between supplying and not supplying power under the control of the monitoring circuit 126 or the processing circuit 150.

The switching device 162 supplies power to at least the first storage device 127 and the processing circuit 150 immediately after the information processing apparatus 100 is activated, i.e., in an initial state. Further, the switching device 162 supplies power to at least one of the display operation device 105, the media sensor 111, the power switch 121, the opening/closing sensor 122, and the second communication device 125 immediately after the information processing apparatus 100 is activated. The switching device 162 may also supply power to the imaging device 116, the driving device 123, the first communication device 124, and/or the first storage device 127 immediately after the information processing apparatus 100 is activated.

This configuration allows the information processing apparatus 100 to control whether to supply power to the display operation device 105, the media sensor 111, the imaging device 116, the power switch 121, the opening/closing sensor 122, the driving device 123, the first communication device 124, the second communication device 125, the first storage device 127, the second storage device 130, or the processing circuit 150 according to the situation. In contrast, the information processing apparatus 100 constantly supplies power to the third storage device 140. In general, initialization of the third storage device 140 takes a long time. Constantly supplying power to the third storage device 140 prevents the third storage device 140 from being initialized other than at the time of activation of the information processing apparatus 100, and the increase in processing time and processing load can be mitigated.

The information processing apparatus 100 also constantly supplies power to the monitoring circuit 126. The information processing apparatus 100 can halt the processing circuit 150, which consumes high power, by causing the monitoring circuit 126, which consumes low power, to monitor whether the condition for resuming the operation of the processing circuit 150 is satisfied. The overall power consumption of the information processing apparatus 100 can thus be reduced.

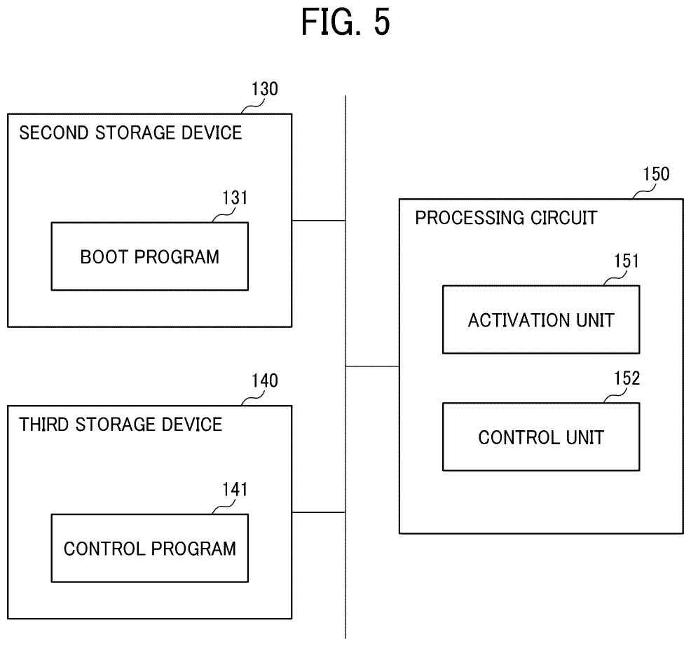

FIG. 5 is a diagram schematically illustrating a configuration of the second storage device 130, the third storage device 140, and the processing circuit 150.

As illustrated in FIG. 5, the second storage device 130 stores, for example, a boot program 131, and the third storage device 140 stores, for example, a control program 141. These programs are functional modules implemented by software that operates on the processor. The processing circuit 150 reads the programs stored in the second storage device 130 and the third storage device 140 and operates according to the read programs. Thus, the processing circuit 150 functions as an activation unit 151 and a control unit 152.

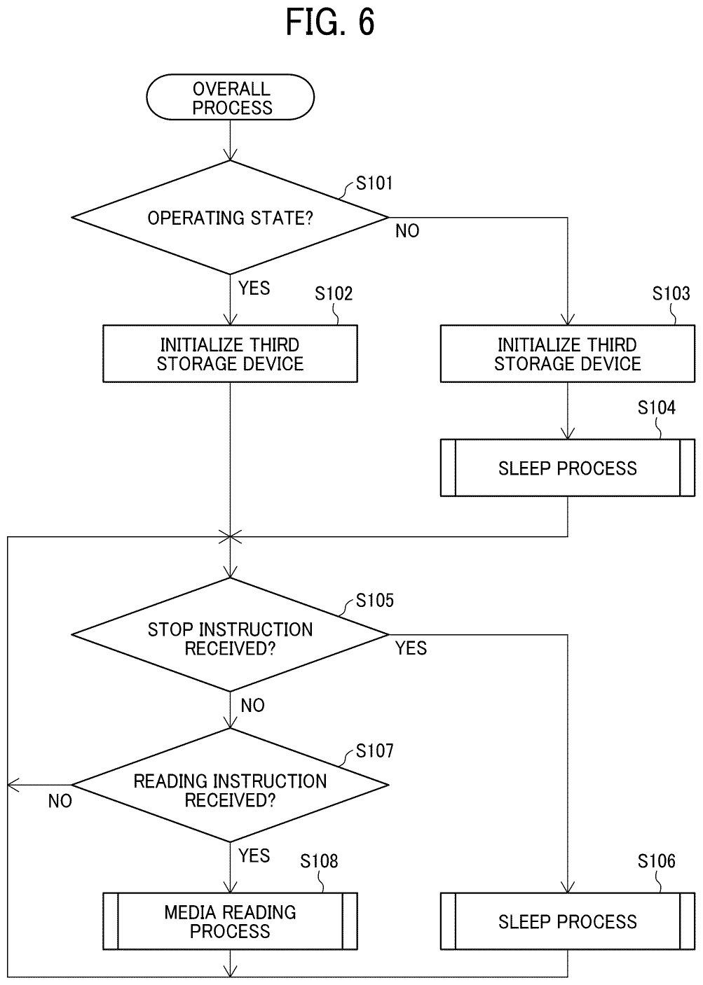

FIG. 6 is a flowchart illustrating an example of operations of an overall process performed in the information processing apparatus 100.

An example of operations of a monitoring process performed in the information processing apparatus 100 will be described hereinafter with reference to the flowchart illustrated in FIG. 6. The flow of the operations described above is executed by, for example, the processing circuit 150 in cooperation with the components of the information processing apparatus 100 according to the programs stored in the second storage device 130 and the third storage device 140 in advance. The overall process is executed immediately after the information processing apparatus 100 is activated. That is, the overall process is executed when the supply device 161 starts supplying power to the third storage device 140 and the processing circuit 150.

First, the activation unit 151 determines whether the state of the information processing apparatus 100 (hereinafter referred to as an “apparatus state”) is an operating state (step S101).

For example, the operating state is a state in which the media tray 103, which is the cover of the information processing apparatus 100, is open. The control unit 152 receives an opening/closing signal from the opening/closing sensor 122 and determines, based on the received opening/closing signal, whether the media tray 103 is open or closed.

The operating state may be a state in which a medium is placed on the media tray 103. The activation unit 151 receives a media signal from the media sensor 111 and determines, based on the received media signal, whether a medium is placed on the media tray 103.

The operating state may be a state in which the communication cable is inserted into the communication connector of the second communication device 125. The activation unit 151 receives an insertion signal from the second communication device 125 and determines, based on the received insertion signal, whether the communication cable is inserted into the communication connector of the second communication device 125.

The operating state may be a state in which the power to the information processing apparatus 100 is on. The activation unit 151 receives a state signal from the power switch 121 and determines, based on the received state signal, whether the power to the information processing apparatus 100 is on. The activation unit 151 may determine that the power to the information processing apparatus 100 is on when an input operation is performed on the display operation device 105 within a predetermined period of time after the information processing apparatus 100 has been activated and an operation signal is received from the display operation device 105. When no input operation is performed on the display operation device 105 within the predetermined period of time after the information processing apparatus 100 has been activated and no operation signal is received from the display operation device 105, the activation unit 151 may determine that the power to the information processing apparatus 100 is off.

The user may open the media tray 103, place a medium on the media tray 103, insert the communication cable into the communication connector, or operate the power switch 121 or the display operation device 105 to set the information processing apparatus 100 to the operating state. Thus, the information processing apparatus 100 can improve user convenience.

When the apparatus state is the operating state, the activation unit 151 outputs an initialization signal to the third storage device 140 to initialize the third storage device 140 (step S102). Further, the activation unit 151 reads a program from the third storage device 140 and loads the program into the first storage device 127. Then, the processing circuit 150 operates according to the program loaded into the first storage device 127. Then, the control unit 152 causes the process to proceed to step S105.

On the other hand, when the apparatus state is not the operating state, as in the processing of step S102, the activation unit 151 initializes the third storage device 140 (step S103). Further, the activation unit 151 reads a program from the third storage device 140 and loads the program into the first storage device 127. Then, the processing circuit 150 operates according to the program loaded into the first storage device 127.

Then, the control unit 152 and the monitoring circuit 126 execute a sleep process (step S104).

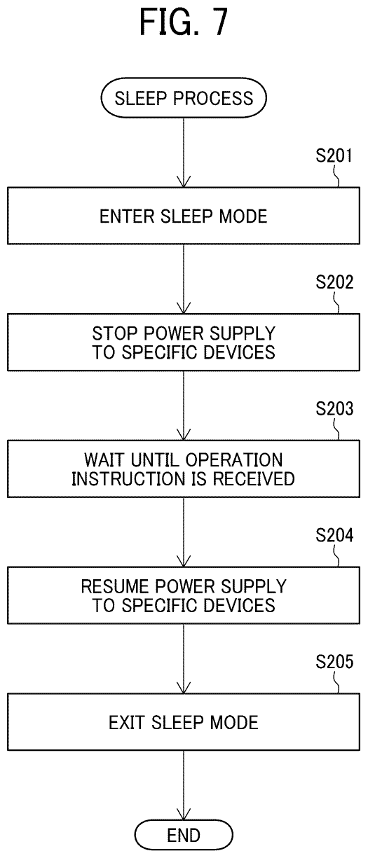

FIG. 7 is a flowchart illustrating an example of operations of the sleep process.

First, the control unit 152 outputs a sleep signal to the third storage device 140 to bring the third storage device 140 into a sleep mode (step S201).

Then, the control unit 152 controls the switching device 162 to stop the supply of power to specific devices (step S202). The specific devices are devices set in advance as devices to which the supply of power is to be stopped when the apparatus state is not the operating state. The specific devices include, for example, the imaging device 116, the driving device 123, the first communication device 124, the first storage device 127, the second storage device 130, and the processing circuit 150. The specific devices may also include at least one of the display operation device 105, the media sensor 111, the power switch 121, the opening/closing sensor 122, and the second communication device 125. By stopping the supply of power to the specific devices, the control unit 152 can reduce the power consumption of the information processing apparatus 100.

The first communication device 124 and/or the second communication device 125 may be excluded from the specific devices. Continuing the supply of power to the first communication device 124 enables a wake-on-wireless LAN (WoWLAN) function, allowing the information processing apparatus 100 to be activated in response to a request from an external device. Continuing the supply of power to the second communication device 125 enables a wake-on-LAN (WoL) function, allowing the information processing apparatus 100 to be activated in response to a request from an external device.

The processing circuit 150 may be excluded from the specific devices. Continuing the supply of power to the processing circuit 150 can omit the monitoring circuit 126, and can reduce the power consumption of the information processing apparatus 100 while reducing the increase in the cost and weight of the information processing apparatus 100. Continuing the supply of power to the processing circuit 150 can also reduce the time taken for the information processing apparatus 100 to transition from a stopped state to the operating state.

Then, the monitoring circuit 126 waits until an operation instruction to request the information processing apparatus 100 to operate is received from the user (step S203).

The operation instruction is, for example, to open the media tray 103, which is the cover of the information processing apparatus 100. The monitoring circuit 126 receives an opening/closing signal from the opening/closing sensor 122 and determines, based on the received opening/closing signal, whether the media tray 103 is open or closed.

The operation instruction may be to place a medium on the media tray 103. The monitoring circuit 126 receives a media signal from the media sensor 111 and determines, based on the received media signal, whether a medium is placed on the media tray 103.

The operation instruction may be to insert the communication cable into the communication connector of the second communication device 125. The monitoring circuit 126 receives an insertion signal from the second communication device 125 and determines, based on the received insertion signal, whether the communication cable is inserted into the communication connector of the second communication device 125.

The operation instruction may be to turn on the power to the information processing apparatus 100. The monitoring circuit 126 receives a state signal from the power switch 121 and determines, based on the received state signal, whether the power to the information processing apparatus 100 is on. The monitoring circuit 126 may determine that the power to the information processing apparatus 100 is on when an input operation is performed on the display operation device 105 and an operation signal is received.

When the operation instruction is received from the user, the monitoring circuit 126 controls the switching device 162 to resume the supply of power to the specific devices to which the supply of power has been stopped in step S202 (step S204).

Then, the control unit 152 outputs an awake signal to the first storage device 127 to bring the third storage device 140 out of the sleep mode (step S205), and then ends the sleep process. The control unit 152 brings the third storage device 140 out of the sleep mode without initializing the third storage device 140.

As described above, when the apparatus state is not the operating state, the control unit 152 initializes the third storage device 140 and then brings the third storage device 140 into a sleep mode. In response to the apparatus state transitioning to the operating state, the control unit 152 brings the third storage device 140 out of the sleep mode without initializing the third storage device 140. For example, in a case where the third storage device 140 is an eMMC, the third storage device 140 consumes significantly less power in the sleep mode than during operation, and the time taken for the third storage device 140 to exit the sleep mode is significantly shorter than the time taken for the third storage device 140 to be initialized. This configuration can reduce the power consumption of the information processing apparatus 100 when the apparatus state is not the operating state, and can make the third storage device 140 usable at an early stage in response to the apparatus state transitioning to the operating state. Accordingly, the information processing apparatus 100 can transition from the stopped state to the operating state in a short time while reducing power consumption.

In the sleep process, the processing of steps S202 and S204 may be omitted.

Referring back to FIG. 6, then, the control unit 152 determines whether a stop instruction to request the information processing apparatus 100 to stop has been received from the user (step S105).

The stop instruction is, for example, to close the media tray 103, which is the cover of the information processing apparatus 100. The control unit 152 receives an opening/closing signal from the opening/closing sensor 122 and determines, based on the received opening/closing signal, whether the media tray 103 is open or closed.

The stop instruction may be to remove the communication cable from the communication connector of the second communication device 125. The control unit 152 receives an insertion signal from the second communication device 125 and determines, based on the received insertion signal, whether the communication cable is inserted into the communication connector of the second communication device 125.

The stop instruction may be to turn off the power to the information processing apparatus 100. The control unit 152 receives a state signal from the power switch 121 and determines, based on the received state signal, whether the power to the information processing apparatus 100 is on. The control unit 152 may determine that the power to the information processing apparatus 100 is off when an input operation remains unimplemented on the display operation device 105 for a predetermined period of time or longer and no operation signal is received from the display operation device 105.

When a stop instruction is received from the user, as in the processing of step S104, the control unit 152 performs the sleep process (step S106). In this case, in step S203, when the media tray 103 is already open, the monitoring circuit 126 may determine that an operation instruction is received from the user in response to the media tray 103 being closed once and reopened. When the communication cable is already inserted into the communication connector of the second communication device 125, the monitoring circuit 126 may determine that an operation instruction is received from the user in response to the communication cable being removed once from the communication connector of the second communication device 125 and re-inserted into the communication connector of the second communication device 125. That is, the control unit 152 may determine that an operation instruction is received from the user in response to the apparatus state based on the media tray 103 or the communication connector of the second communication device 125 transitioning to a state that is not the operating state once and then returning to the operating state. Then, the control unit 152 returns the process to step S105 and repeats the process from step S105.

As described above, when the apparatus state is the operating state in a case where the supply device 161 starts the supply of power to the third storage device 140 and the processing circuit 150 and when no operation is received from the user in a predetermined period of time after the third storage device 140 has been initialized, the control unit 152 brings the third storage device 140 into a sleep mode. Thereafter, in response to receipt of an operation from the user or in response to the apparatus state transitioning to a state that is not the operating state once and returning to the operating state, the control unit 152 brings the third storage device 140 out of the sleep mode without initializing the third storage device 140. This configuration can reduce the power consumption of the information processing apparatus 100 when no operation is performed by the user for a certain period of time, and can make the third storage device 140 usable at an early stage in response to the apparatus state transitioning to the operating state. Accordingly, the information processing apparatus 100 can transition from the stopped state to the operating state in a short time while reducing power consumption.

On the other hand, when a stop instruction is not received from the user, the control unit 152 determines whether a media reading instruction is received from the user (step S107). When the user inputs an instruction to read the media using the display operation device 105 or a communication device and an operation signal indicating an instruction to read the media is received from the display operation device 105, the first communication device 124, or the second communication device 125, the control unit 152 receives a media reading instruction. When no media reading instruction is received, the control unit 152 returns the process to step S105 and repeats the process from step S105.

On the other hand, when a media reading instruction is received, the control unit 152 performs a media reading process (step S108). Then, the control unit 152 returns the process to step S105 and repeats the process from step S105.

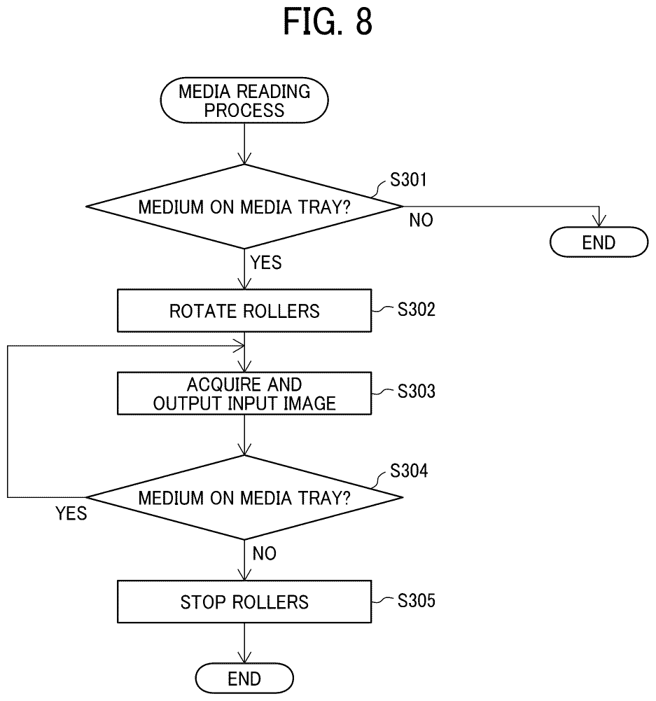

FIG. 8 is a flowchart of an example of operations of the media reading process.

First, the control unit 152 acquires a media signal from the media sensor 111 and determines, based on the acquired media signal, whether a medium is placed on the media tray 103 (step S301). When no medium is placed on the media tray 103, the control unit 152 ends the media reading process.

On the other hand, when a medium is placed on the media tray 103, the control unit 152 controls the driving device 123 to rotate the feed roller 112, the separation roller 113, the first conveyance roller 114, the second conveyance roller 115, the first ejection roller 117, and/or the second ejection roller 118 to convey the medium (step S302).

Then, the control unit 152 causes the imaging device 116 to capture an image of the medium, acquires an input image from the imaging device 116, and transmits the acquired input image to another communication device via the first communication device 124 or the second communication device 125 to output the input image (step S303).

Then, the control unit 152 determines whether a medium remains on the media tray 103, based on the media signal received from the media sensor 111 (step S304). When a medium remains on the media tray 103, the control unit 152 returns the process to step S303 and repeats the processing of steps S303 and S304.

On the other hand, when no medium remains on the media tray 103, the control unit 152 controls the driving device 123 to stop the feed roller 112, the separation roller 113, the first conveyance roller 114, the second conveyance roller 115, the first ejection roller 117, and/or the second ejection roller 118 (step S305). Then, the control unit 152 ends the media reading process.

As described above in detail, when the apparatus state is not the operating state at the start of the supply of power to the information processing apparatus 100, the information processing apparatus 100 initializes the third storage device 140 and then brings the third storage device 140 into a sleep mode. Then, in response to the apparatus state transitioning to the operating state, the information processing apparatus 100 brings the third storage device 140 out of the sleep mode without initializing the third storage device 140. Accordingly, the information processing apparatus 100 can transition from the stopped state to the operating state in a short time while reducing power consumption. Thus, the information processing apparatus 100 can appropriately control the third storage device 140, which is a non-volatile memory.

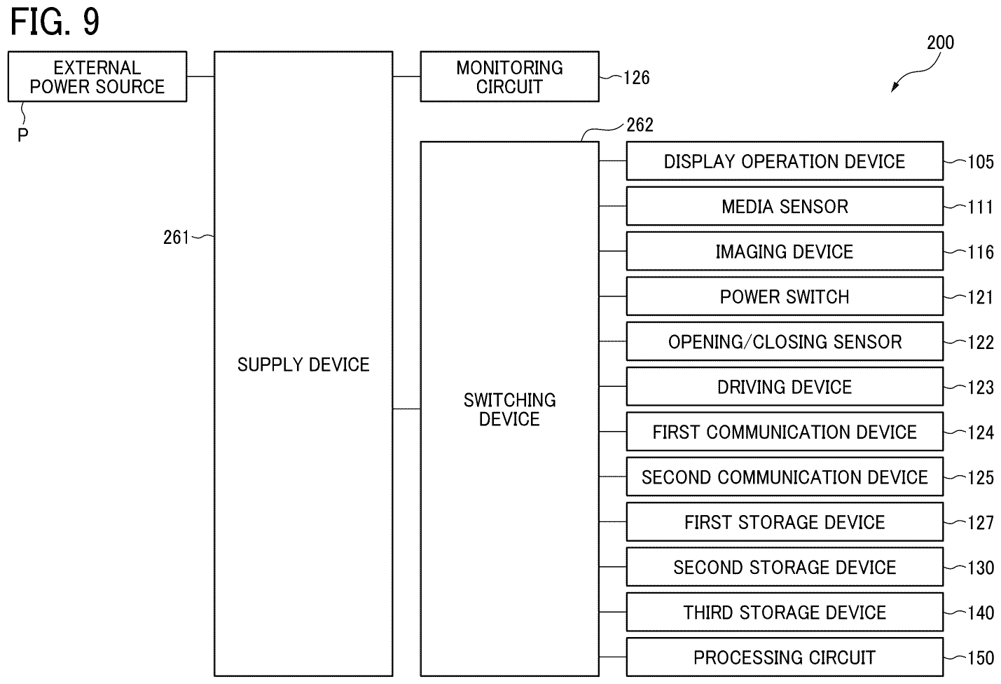

FIG. 9 is a schematic diagram illustrating a power supply mechanism of an information processing apparatus according to another embodiment.

An information processing apparatus 200 according to the present embodiment has a configuration and functions similar to those of the information processing apparatus 100. The information processing apparatus 200 includes a supply device 261 and a switching device 262 instead of the supply device 161 and the switching device 162.

The supply device 261 has a configuration and functions similar to those of the supply device 161. The supply device 261 also supplies the power supplied from the external power source P to the third storage device 140 through the switching device 262. The supply device 261 supplies the power supplied from the external power source P directly to the monitoring circuit 126 by bypassing the switching device 262.

The switching device 262 has a configuration and functions similar to those of the switching device 162. The switching device 262 switches between supplying and not supplying the power, which is supplied from the external power source P to the supply device 261, to the third storage device 140. The switching device 262 switches between supplying and not supplying power under the control of the monitoring circuit 126 or the processing circuit 150. The switching device 262 supplies power to the third storage device 140 immediately after the information processing apparatus 200 is activated. In one example, the switching device 262 does not supply power to the third storage device 140 immediately after the information processing apparatus 200 is activated.

This configuration allows the information processing apparatus 200 to control whether to supply power to the third storage device 140 according to the situation.

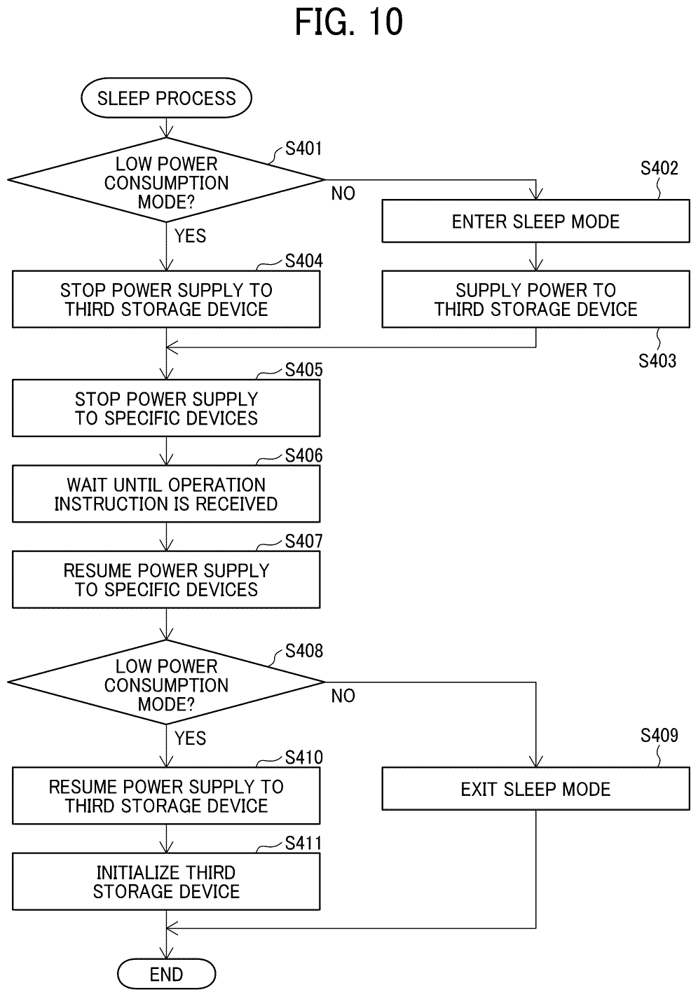

FIG. 10 is a flowchart illustrating another example of the operations of the sleep process.

The sleep process illustrated in FIG. 10 is executed instead of the sleep process illustrated in FIG. 7. Since the processing of steps S405 to S407 illustrated in FIG. 10 is similar to the processing of steps S202 to S204 illustrated in FIG. 7, a description thereof will be omitted. The following describes the processing of steps S401 to S404 and S408 to S411. The information processing apparatus 200 has a normal mode and a low power consumption mode as operation modes. Any one of the operation modes is set by the user using the display operation device 105 or another communication device and is stored in the second storage device 130 in advance.

First, the control unit 152 determines which of the normal mode and the low power consumption mode is set as the operation mode (step S401).

When the normal mode is set as the operation mode, as in the processing of step S201 in FIG. 7, the control unit 152 brings the third storage device 140 into a sleep mode (step S402).

Then, the control unit 152 controls the switching device 262 to supply power to the third storage device 140 (step S403).

On the other hand, when the low power consumption mode is set as the operation mode in step S401, the control unit 152 controls the switching device 262 to stop the supply of power to the third storage device 140 (step S404).

As described above, when the apparatus state is not the operating state, the control unit 152 continues the supply of power to the third storage device 140 during operation in the normal mode, and stops the supply of power to the third storage device 140 during operation in the low power consumption mode. This configuration allows the information processing apparatus 200 to change the priority between the reduction in power consumption or the reduction in time taken for the information processing apparatus 200 to transition from the stopped state to the operating state, depending on the operation mode, and can improve user convenience.

In step S408, the control unit 152 determines which of the normal mode and the low power consumption mode is set as the operation mode (step S408).

When the normal mode is set as the operation mode, as in the processing of step S205 in FIG. 7, the control unit 152 brings the third storage device 140 out of the sleep mode (step S409), and then ends the sleep process.

On the other hand, when the low power consumption mode is set as the operation mode, the control unit 152 controls the switching device 262 to resume the supply of power to the third storage device 140 (step S410).

Then, as in the processing of step S102 in FIG. 6, the control unit 152 initializes the third storage device 140 (step S411), and then ends the sleep process.

As described above in detail, the information processing apparatus 200 having the normal mode and the low power consumption mode can also appropriately control the third storage device 140, which is a non-volatile memory.

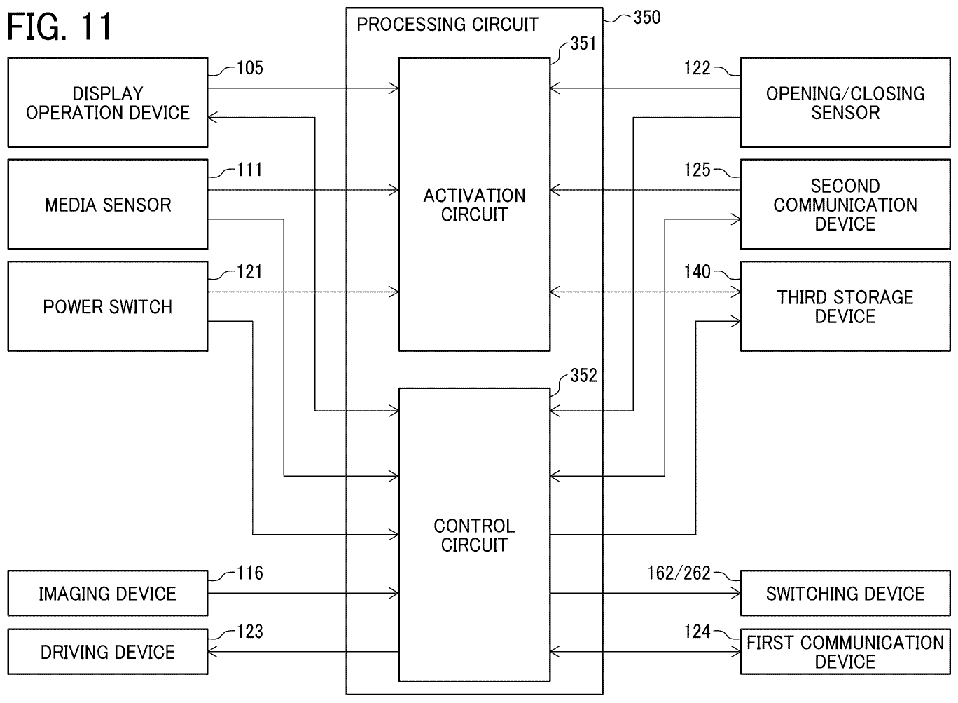

FIG. 11 is a diagram schematically illustrating a configuration of a processing circuit in an information processing apparatus according to another embodiment.

A processing circuit 350 is used instead of the processing circuit 150, and executes the overall process instead of the processing circuit 150. The processing circuit 350 includes, for example, an activation circuit 351 and a control circuit 352. The activation circuit 351 and the control circuit 352 may be, for example, independent integrated circuits, microprocessors, or firmware.

The activation circuit 351 is an example of an activation unit and has a function similar to that of the activation unit 151. The activation circuit 351 receives an operation signal from the display operation device 105, receives a media signal from the media sensor 111, receives a state signal from the power switch 121, receives an opening/closing signal from the opening/closing sensor 122, and receives an insertion signal from the second communication device 125. The activation circuit 351 controls the third storage device 140, based on the received signals.

The control circuit 352 is an example of circuitry and functions in the same or substantially the same manner as the control unit 152. The control circuit 352 receives an operation signal from the display operation device 105, receives a media signal from the media sensor 111, receives a state signal from the power switch 121, receives an opening/closing signal from the opening/closing sensor 122, and receives an insertion signal from the second communication device 125. The control circuit 352 controls the third storage device 140 and the switching device 162 or 262, based on the received signals. Further, the control circuit 352 controls the driving device 123 based on the operation signal and the media signal, and acquires an input image from the imaging device 116 to output the input image to the first communication device 124 or the second communication device 125.

As described above in detail, the information processing apparatus including the processing circuit 350 can also appropriately control the third storage device 140, which is a non-volatile memory.

Embodiments of the present disclosure are not limited to the embodiments described above. In an embodiment, for example, the information processing apparatus may include a media conveying path that is a so-called U-turn path to sequentially feed and convey the media placed on the media tray one by one, starting from the top, and eject the media to the ejection tray. In this configuration, the separation roller is located below the feed roller and faces the feed roller.

In another embodiment, the information processing apparatus may include an image forming device instead of or in addition to the imaging device 116. The image forming device is, for example, an inkjet or laser printer, and is located at the position corresponding to the position of the imaging device 116 to form an image (print predetermined information) on a medium conveyed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising:
a non-volatile memory that stores a program, the non-volatile memory being operable in response to being initialized and having a sleep function;
processing circuitry configured to execute a process; and
a supply device to supply power supplied from an external power source to the non-volatile memory and the processing circuitry,
wherein the processing circuitry is configured to:
initialize the non-volatile memory when a state of the information processing apparatus is an operating state in a case where the supply device starts to supply the power to the non-volatile memory and the processing circuitry;
when the state of the information processing apparatus is not the operating state in the case where the supply device starts to supply the power to the non-volatile memory and the processing circuitry, bring the non-volatile memory into a sleep mode after initializing the non-volatile memory; and
when the state of the information processing apparatus transitions to the operating state, bring the non-volatile memory out of the sleep mode without initializing the non-volatile memory.

2. The information processing apparatus according to claim 1, wherein
the processing circuitry controls conveying of a medium in the information processing apparatus, and the operating state includes any one of:
a state in which a cover of the information processing apparatus is open;
a state in which a medium is placed on a media tray;
a state in which a communication cable is inserted into a communication connector of the information processing apparatus; and
a state in which the information processing apparatus is turned on.

3. The information processing apparatus according to claim 1, further comprising a switching device to switch between supplying and not supplying the power supplied to the supply device to the processing circuitry, wherein
the supply device supplies the supplied power to the non-volatile memory by bypassing the switching device.

4. The information processing apparatus according to claim 1, wherein
the information processing apparatus has a normal mode and a low power consumption mode, and
when the state of the information processing apparatus is not the operating state, the processing circuitry is configured to:
continue supply of the power to the non-volatile memory during operation in the normal mode; and
stop the supply of the power to the non-volatile memory during operation in the low power consumption mode.

5. The information processing apparatus according to claim 1, wherein
the processing circuitry is configured to:
bring the non-volatile memory into a sleep mode when the state of the information processing apparatus is the operating state in the case where the supply device starts to supply the power to the non-volatile memory and the processing circuitry and when no operation is received from a user in a predetermined period of time after the non-volatile memory has been initialized; and
after bringing the non-volatile memory into the sleep mode, in response to receipt of an operation from the user or in response to the state of the information processing apparatus transitioning to a state that is not the operating state once and returning to the operating state, bring the non-volatile memory out of the sleep mode without initializing the non-volatile memory.

6. An information processing method performed by an information processing apparatus, the method comprising:
supplying, by a supply device, power supplied from an external power source to a non-volatile memory that stores a program and processing circuitry that execute a process, the non-volatile memory being operable in response to being initialized and having a sleep function;
initializing the non-volatile memory when a state of the information processing apparatus is an operating state in a case where the supply device starts to supply the power to the non-volatile memory and the processing circuitry; and
when the state of the information processing apparatus is not the operating state in the case where the supply device starts to supply the power to the non-volatile memory and the processing circuitry, bringing the non-volatile memory into a sleep mode after initializing the non-volatile memory; and
when the state of the information processing apparatus transitions to the operating state, bringing the non-volatile memory out of the sleep mode without initializing the non-volatile memory.

7. A computer-readable, non-transitory medium storing a computer program, which, when executed by processing circuitry, an information processing apparatus to perform an information processing method, the information processing apparatus including a non-volatile memory that is operable in response to being initialized and having a sleep function, the processing circuitry, and a supply device to supply power supplied from an external power source to the non-volatile memory and the processing circuitry, the information processing method comprising:
initializing the non-volatile memory when a state of the information processing apparatus is an operating state in a case where the supply device starts to supply the power to the non-volatile memory and the processing circuitry;
when the state of the information processing apparatus is not the operating state in the case where the supply device starts to supply the power to the non-volatile memory and the processing circuitry, bringing the non-volatile memory into a sleep mode after initializing the non-volatile memory; and
when the state of the information processing apparatus transitions to the operating state, bringing the non-volatile memory out of the sleep mode without initializing the non-volatile memory.
